(19) United States
(12) Patent Application Publication
(10) Pub. No.: US 2013/0135631 A1
(43) Pub. Date: May 30, 2013

(54) PRINTER, SYSTEM AND METHOD FOR MONITORING PRINT QUALITY

(71) Applicant: Wen-Chi Lin, New Taipei City (TW)

(72) Inventor: Wen-Chi Lin, New Taipei City (TW)

(73) Assignees: Cal-Comp Electronics & Communications Company Limited, New Taipei City (TW); KINPO ELECTRONICS, INC., New Taipei City (TW)

(21) Appl. No.: 13/530,116

(22) Filed: Jun. 22, 2012

(30) Foreign Application Priority Data
Nov. 29, 2011 (TW) 100143743

(51) Int. Cl. H04N 1/60; G06K 15/02

(52) U.S. Cl. 358/1.9; 358/1.13

(57) ABSTRACT

A printer, a system and a method for monitoring print quality are provided. In this method, during a printout process of a document, the document is scanned at the same time, and scan information is obtained after the printout process is completed. Original information relating to the document is compared against the scan information to determine whether a data loss occurs. An abnormal print message is displayed to warn the user when there is a data loss or the data loss is occurred; otherwise, a normal print message is displayed.

### CROSS-REFERENCE TO RELATED APPLICATION

This application claims the priority benefit of Taiwan application serial no. 100143743, filed on Nov. 29, 2011. The entirety of the above-mentioned patent application is hereby incorporated by reference herein and made a part of this specification.

### BACKGROUND OF THE INVENTION

1. Field of the Invention

The present invention relates to a print technology, and more particularly, to a printer, a system and a method for monitoring print quality.

2. Description of Related Art

For users of computer apparatus, printers are a most common peripheral device. The user can output characters or figures onto paper through the printer.

In current print systems, a user sends a print command through the computer apparatus, and a printer prints original information transmitted from the computer apparatus without monitoring the print quality of a printed document. Common printers include ink jet printers and laser printers. The ink jet printers utilize a nozzle to print, while the laser printers utilize xerographic copy by means of a laser beam and a drum. If the nozzle of the ink-jet printer is blocked, or an electrostatic latent image on the drum cannot be clearly developed, the print quality would be degraded. If the user uses the printer to print in these situations, because the print quality is degraded but the user does not know the degraded print quality, it would cause a waste of paper, especially when a large quantity of documents or report sheets are printed. If the print quality is very poor, important data even cannot be presented on paper in its integrality.

Obviously, when a data loss occurs in a printed document but the user cannot be effectively notified of such data loss, it would leave the user with a negative impression in using the printer. What is needed, therefore, is to present characters or figures the user wishes to express on print media in their integrality to faithfully fulfill the print task.

### SUMMARY OF THE INVENTION

Accordingly, the present invention is directed to a printer, a print quality monitoring system and method to address the problems discussed above.

The present invention provides a print quality monitoring method. In this method, during a printout process of a document, the document is scanned at the same time, and scan information is obtained after the printout process is completed. Original information relating to the document is compared against the scan information to determine whether a data loss occurs. An abnormal print message is displayed when there is a data loss or the data loss is occurred.

The present invention additionally provides a printer which includes a control module, a print module, and a scan module. The control module is configured to be served as an operation core of the printer. The print module is controlled by the control module and configured to print a document. The scan module is controlled by the control module and configured to scan the document at the same time during a printout process of the document, and obtain and transmit scan information to a computer equipment corresponding to the document after the printout process is completed. Upon receiving the scan information, the computer equipment compares original information of the document against the scan information to determine whether there is a data loss; and displays an abnormal print message to warn the user when there is a data loss or the data loss is occurred.

The present invention further provides a print quality control system which includes a computer equipment, a print module and a scan module. The computer equipment is configured to output original information of a document. The print module is configured to receive the original information and print the document. The scan module is configured to scan the document at the same time during a printout process of the document, and obtain and transmit scan information to the computer equipment after the printout process is completed. Upon receiving the scan information, the computer equipment compares original information against the scan information to determine whether there is a data loss; and displays an abnormal print message when there is a data loss or the data loss is occurred.

In one embodiment, after determining that there is a data loss or the data loss is occurred, whether there is remaining print pigment is determined. When it is determined that there is remaining print pigment, the displayed abnormal print message includes that a nozzle or a drum of a print module relating to the document has a problem. When it is determined that there is no remaining print pigment, the displayed abnormal print message includes that an ink cartridge or a toner cartridge of the print module has run out.

In one embodiment, the printer may be an ink jet printer or a laser printer, and the scan module may be a contact image sensor.

In view of the foregoing, in the print quality monitoring mechanism of the present invention, during a printout process of a document, the document is scanned at the same time, and whether a data loss occurs is determined. If there is no data loss, a normal print message is displayed; if there is a data loss, an abnormal print message is displayed. A warning message may further be displayed according to the print pigment (ink cartridge or toner cartridge) remainder information, which can effectively notify the user of the specific print error so that the user can fix the error.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The following drawings accompanying and forming a part of this specification are directed to exemplary embodiments of the present invention, and the drawings and the description of the specification are used together to explain the principle of the present invention.

FIG. 1A illustrates a print quality monitoring system according to one embodiment of the present invention.

FIG. 1B illustrates an ink jet print quality monitoring system according to one embodiment of the present invention.

FIG. 1C illustrates a laser print quality monitoring system according to one embodiment of the present invention.

FIG. 2 is a flow chart of a print quality monitoring method according to one embodiment of the present invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. Where possible, the same reference numerals refer to the same or similar elements/components throughout the drawings and specification.

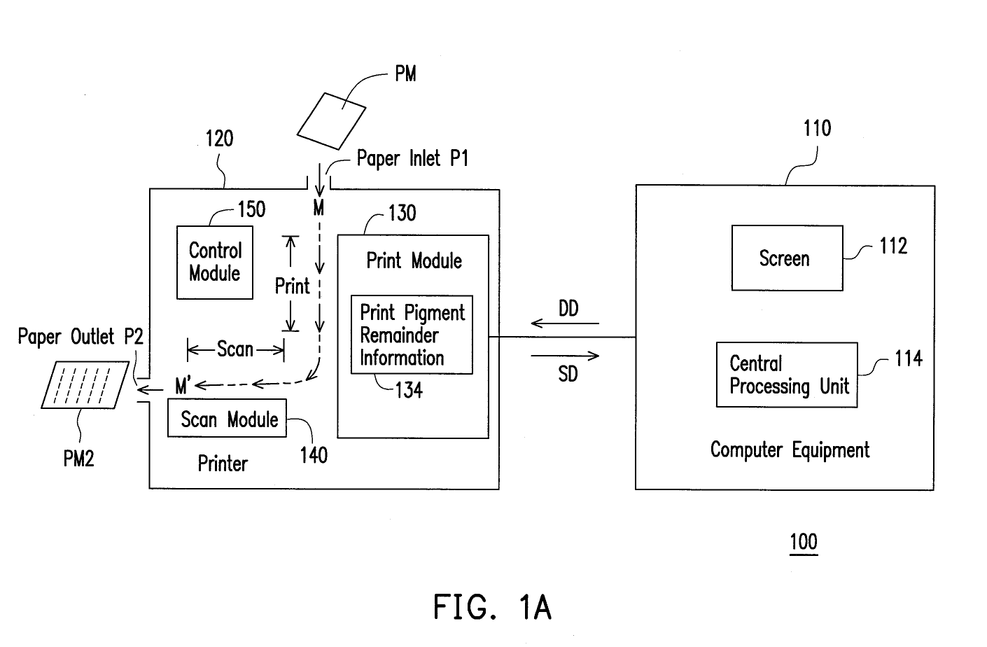

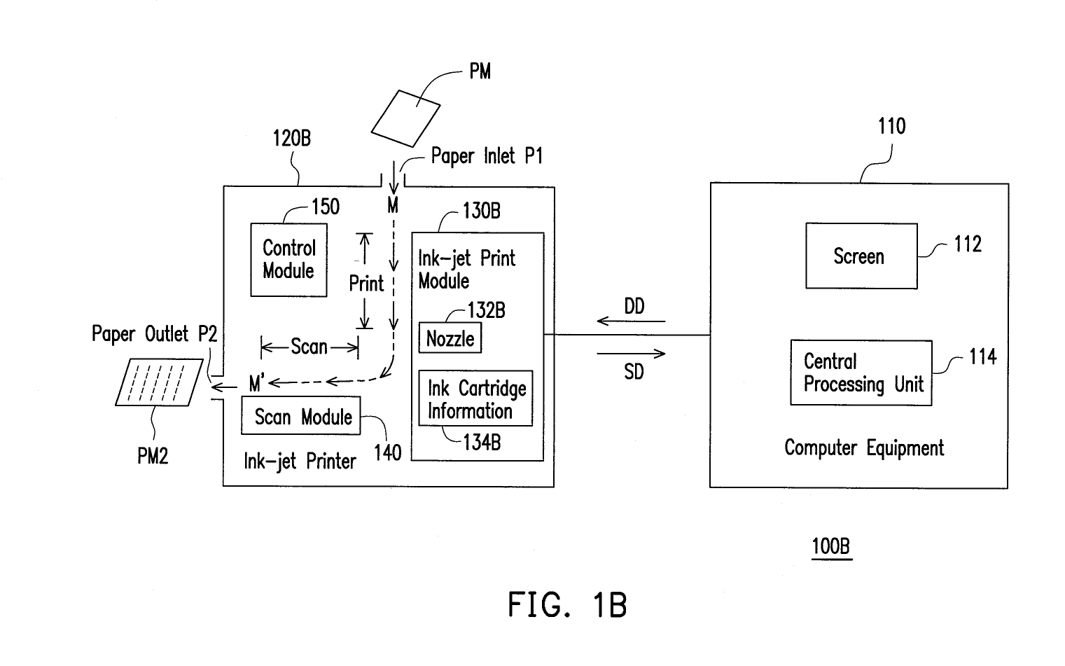

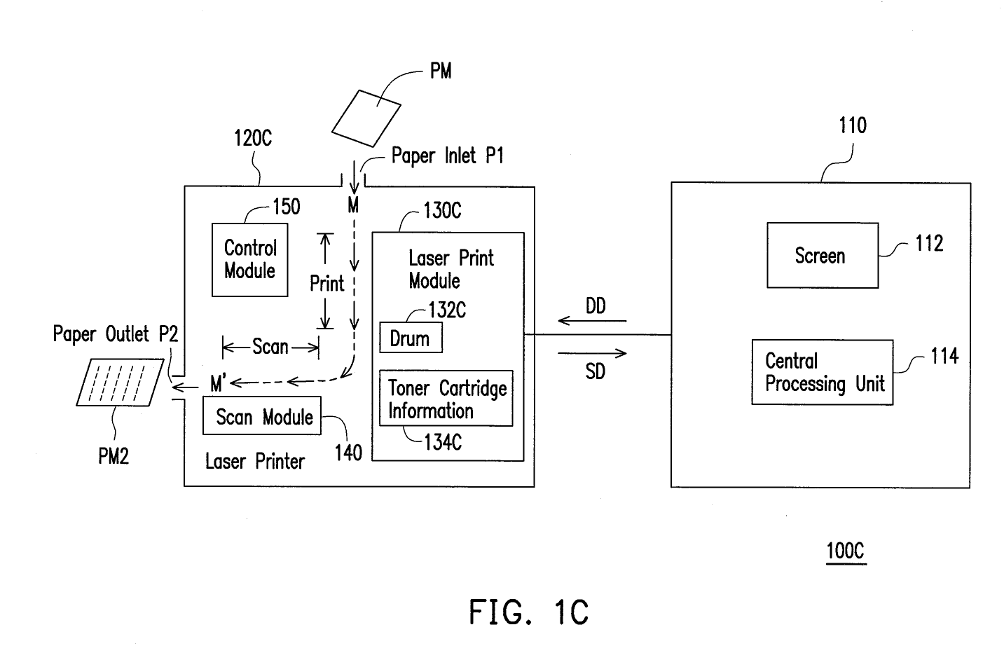

FIG. 1A illustrates a print quality monitoring system 100 according to one embodiment of the present invention. Referring to FIG. 1A, the print quality monitoring system 100 may include a computer equipment 110 and a printer 120. The term “computer equipment” used herein is a common term for an electronic device having a screen 112 and a central processing unit 114, which may be a personal digital assistant (PDA) or notebook computer having a built-in screen, or a desk-top computer or a super computer used in combination with an external screen 112. Thus, the computer equipment 120 used herein is not intended to be limited to any particular type of computer equipment. The printer 120 includes a print module 130, a scan module 140, and a control module 150. The control module 150 is configured to be served as an operation core of the printer 120, and the print module 130 and the scan module 140 are controlled by the control module 150.

On the other hand, the body of an all-in-one printer (or referred to as multi-function printer, MFP)(not shown) includes a computer equipment 110, a printer 120 as well as devices of other functions, the print quality monitoring system 100 may be applied in the MFP. It is noted, however, that application of the print quality monitoring system 100 is not intended to be limited to the above mentioned MFP.

In the present embodiment, the computer equipment 110 outputs original information DD relating to a document to the printer 120. Upon receiving the original information DD, the print module 130 of the printer 120 allows a print media PM to enter the printer 120 via a paper inlet P1 and advance along a feed path MM', and prints the original information DD on the print media PM in an ink-jetting manner (FIG. 1B) or laser scanning manner (FIG. 1C) to produce the desired document. The print media PM may be paper, a transparent film or a color film. It is noted, however, that the print media PM is not intended to be limited to any particular type disclosed herein.

The scan module 140 may be disposed downstream the print module 130. The scan module 140 may be, but not limited to, a contact image sensor (CIS). During a printout process to produce the document, the print media PM continuously advances along the feed path MM′ and the scan module 140 scans the print media PM (the document) at the same time and, after the printout process is completed, allows the print media PM to be outputted to an outside via a paper outlet P2 (for example, the illustrated print media PM2 is the outputted document). At this time, the scan module 140 obtains scan information SD relating to the document, and feeds the scan information SD back to the computer equipment 110.

Upon receiving the scan information SD, the central process unit 114 of the computer equipment 110 starts comparing the scan information SD against the original information DD. If it is determined that a data loss does not occur, a normal print message can be displayed on the screen 112. Otherwise, if it is determined that a data loss occurs, an abnormal print message is displayed on the screen 112.

Notably, in case of a data loss, the central processing unit 114 can further pick up print pigment remainder information 134 relating to the print module 130. If it is determined that there is remaining print pigment, the displayed abnormal print message may include that a nozzle (element 132B as shown in FIG. 1B) or a drum (element 132C as shown in FIG. 1C) of the print module 130 relating to the document has a problem. If it is determined that there is no remaining print pigment, the displayed abnormal print message may include that the ink cartridge or the toner cartridge has run out to warn the user.

As described above, the present embodiment scans the printed document at the same time and compares the scan information against the original information. If it is determined that there is no data loss, the normal print message may be displayed; if it is determined that there is a data loss, a warning message is further produced according to the print pigment (ink cartridge or toner cartridge) remainder information, allowing the user to know the cause of the print error, so that the user can fix the problem.

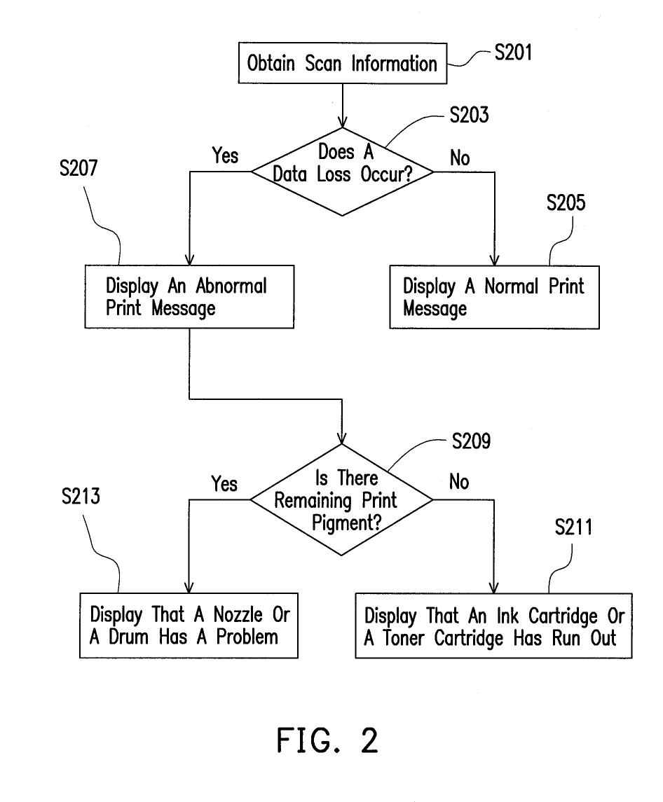

FIG. 1B illustrates an ink-jet print quality monitoring system 100B according to one embodiment of the present invention. FIG. 2 is a flow chart of an ink-jet print quality monitoring method according to one embodiment of the present invention. The operation of the ink-jet print quality monitoring system 100B is described below in detail with reference to another embodiment.

Referring to FIG. 1B and FIG. 2, at step S201, the computer equipment 110 outputs the original information DD to an ink jet printer 120B. Upon receiving the original information DD, the ink-jet print module 130B of the ink-jet printer 120 outputs the original information DD to the print media PM to produce a document in an ink-jetting manner. The document is scanned during a printout process of the document by the san module 140. After the printout process is completed, scan information SD is obtained.

At step S203, the central processing unit 114 of the computer equipment 110 then compares the original information DD against the scan information SD to determine whether a data loss occurs.

If it is determined that no data loss occurs, then a normal print message is displayed on the screen 112 of the computer equipment 110 at step S205.

If it is determined that a data loss occurs, then an abnormal print message is displayed on the screen 112 to warn the user at step S207.

After determining that a data loss occurs, the central processing unit 114 may pick up the ink cartridge information 134B (print pigment remainder information) relating to the ink jet print module 130B and determine whether there is remaining print pigment according to the ink cartridge information 134B at step S209.

If it is determined that there is no remaining print pigment (ink), then a message that the ink cartridge has run out is displayed on the screen 112 at step S211.

If it is determined that there is remaining print pigment (ink), then a nozzle error message is displayed on the screen 112 at step S213. In general, when there is remaining print pigment, abnormalities of the ink-jet print module 130B are mostly because that the nozzle 132B is crooked or blocked. If the nozzle 132B is crooked, it can be very difficult in controlling the direction and size of the ink particles, and the print lines can easily have uneven edges, which affects the print quality; the abnormalities may also be because the ink dries out and blocks the nozzle 132B. As such, the printer may warn the user of the specific cause of the print error to facilitate the user checking or replacing the nozzle 132B.

Another embodiment is given below to make people skilled in the art gain a more comprehensive understanding of the present invention. FIG. 1C illustrates a laser print quality monitoring system 100c according to an embodiment of the present invention.

Referring to FIG. 1C and FIG. 2, the steps of obtaining scan information of a document from the laser printer 120C, determining whether a data loss occurs, and displaying a normal/abnormal print message are similar to the steps S201 to S207 described with respect to the ink-jet printer 120B and, therefore, are not repeated herein.

After determining a data loss occurs, the central processing unit 114 may then pick up the toner cartridge information 134C (print pigment remainder information) relating to the laser print module 130C and determine whether there is remaining print pigment according to the toner cartridge information 134C at step S209.

If it is determined that there is no remaining print pigment (toner), then a message that the toner cartridge has run out is displayed on the screen 112 at step S211.

If it is determined that there is remaining print pigment (toner), then a drum error message is displayed on the screen 112 at step S213. In general, when there is remaining print pigment, abnormalities of the laser print module 130C are mostly because that an electrostatic latent image on the drum 132C cannot be clearly developed. As such, the print quality monitoring system 100C facilitates the user checking or replacing the drum 132C to fix the problem.

In summary, in the print quality monitoring mechanism of the present invention, during a printout process of a document, the document is scanned at the same time, and whether a data loss occurs is determined. If there is no data loss, a normal print message is displayed; if there is a data loss, an abnormal print message is displayed. A warning message may further be displayed according to the print pigment (ink cartridge or toner cartridge) remainder information, which can effectively notify the user of the cause of the print error so that the user can fix the error.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A print quality monitoring method comprising:
during a printout process of a document, scanning the document at the same time, and obtaining scan information after the printout process is completed;
comparing original information relating to the document against the scan information to determine whether a data loss occurs; and
displaying an abnormal print message when the data loss is occurred.

2. The print quality monitoring method according to claim 1, wherein after determining that the data loss is occurred, the print quality monitoring method further comprising:
determining whether there is remaining print pigment;
when it is determined that there is remaining print pigment, the displayed abnormal print message comprises that a nozzle or a drum of a print module relating to the document has a problem; and
when it is determined that there is no remaining print pigment, the displayed abnormal print message comprises that an ink cartridge or a toner cartridge of the print module has run out.

3. The print quality monitoring method according to claim 1, further comprising:
displaying a normal print message when the data loss is not occurred.

4. A printer comprising:
a control module configured to be served as an operation core of the printer;
a print module controlled by the control module and configured to print a document; and
a scan module controlled by the control module and configured to scan the document at the same time during a printout process of the document, and obtain and transmit scan information to a computer equipment corresponding to the document after the printout process is completed;
wherein upon receiving the scan information, the computer equipment compares original information of the document against the scan information to determine whether there is a data loss; and displays an abnormal print message when the data loss is occurred.

5. The printer according to claim 4, wherein the printer is an ink jet printer or a laser printer.

6. The printer according to claim 4, wherein the scan module is a contact image sensor.

7. The printer according to claim 4, wherein after determining that the data loss is occurred, the computer equipment picks up print pigment remainder information relating to the print module, and determines whether there is remaining print pigment according to the print pigment remainder information; when it is determined that there is remaining print pigment, the displayed abnormal print message comprises that a nozzle or a drum of the print module relating to the document has a problem; and when it is determined that there is no remaining print pigment, the displayed abnormal print message comprises that an ink cartridge or a toner cartridge of the print module has run out.

8. The printer according to claim 4, wherein the computer equipment displays a normal print message when the data loss is not occurred.

9. A print quality monitoring system comprising:
a computer equipment configured for outputting original information of a document;
a print module configured for receiving the original information and printing the document; and
a scan module configured for scanning the document at the same time during a printout process of the document, and obtaining and transmitting scan information to the computer equipment after the printout process is completed;
wherein upon receiving the scan information, the computer equipment compares original information against the scan information to determine whether there is a data loss; and displays an abnormal print message when the data loss is occurred.

10. The print quality monitoring system according to claim 9, wherein the printer is an ink-jet printer or a laser printer.

11. The print quality monitoring system according to claim 9, wherein the scan module is a contact image sensor.

12. The print quality monitoring system according to claim 9, wherein after determining that the data loss is occurred, the computer equipment picks up print pigment remainder information relating to the print module, and determines whether there is remaining print pigment according to the print pigment remainder information; when it is determined that there is remaining print pigment, the displayed abnormal print message comprises that a nozzle or a drum of the print module relating to the document has a problem; and when it is determined that there is no remaining print pigment, the displayed abnormal print message comprises that an ink cartridge or a toner cartridge of the print module has run out.

13. The print quality monitoring system according to claim 9, wherein the computer equipment displays a normal print message when the data loss is not occurred.
